(19) United States
(12) Patent Application Publication
(10) Pub. No.: US 2012/0141085 A1
(43) Pub. Date: Jun. 7, 2012

(54) FIBER CLAMP MECHANISM

(75) Inventor: Fumio Aoki, Kawasaki-shi (JP)

(73) Assignee: FUJITSU TELECOM NETWORKS LIMITED, KAWASAKI-SHI, KANAGAWA (JP)

(21) Appl. No.: 13/389,980

(22) PCT Filed: Nov. 20, 2009
(86) PCT No.: PCT/JP2009/006259

§ 371 Date: Feb. 10, 2012

(51) Int. Cl. G02B 6/00

(52) U.S. Cl. 385/136

(57) ABSTRACT

A fiber clamp mechanism of an optical fiber fusion splicer includes a fiber receiving base and a clamp tip attached to a tip of a stay, in which the fiber receiving base is formed to have a substantially L-shaped cross section in which a thin-walled projecting piece is provided to project upward, and a V-groove with a thin wall holding an optical fiber is formed on an upper surface of the projecting piece, the clamp tip is formed to have a substantially L-shaped cross section in which a projecting piece having a V-shaped pressing portion with a thin wall formed along the V-groove projects downward and is fixed to the tip of the stay, and a tip of the V-shaped pressing portion is formed to have an R-shape along an axial direction of the optical fiber.

### CROSS-REFERENCE TO RELATED APPLICATION

This application is U.S. National Stage application claiming the benefit of prior filed International Application Number PCT/JP2009/006259, filed Nov. 20, 2009, the entire contents of which are incorporated herein by reference.

### TECHNICAL FIELD

The present invention relates to a fiber clamp device, and specifically relates to a fiber clamp mechanism of an optical fiber fusion splicer used for fusion-splicing optical fibers.

### BACKGROUND ART

In recent years, there has been a great need for a communication apparatus to realize ultrahigh capacity, ultra-long distance, ultrahigh speed, and low cost, and for the realization, an application of photonic network technology capable of performing signal processing (demultiplexing, branching and inserting, cross connect) without converting an optical signal in a transmission line into an electrical signal, has been rapidly expanded.

Incidentally, on a unit configuring an optical circuit used for the photonic network (an optical module, an optical mounting printed-circuit board or the like), optical parts to be mutually connected (connected by an optical connector or optically spliced) are mounted, and a quantity thereof has been on the increase.

However, regarding the connection using the optical connector, an outer shape of the connector is large, an adapter and a fixing part required for the connector connection are necessary, a large mounting area is required, and a connection loss is also relatively large, so that when splicing optical fibers, there has been widely used optical splicing capable of reducing a size of a spliced portion and capable of reducing a splice loss as well, as disclosed in Patent Document 1.

Further, recently, when conducting the optical splicing, fusion splicing in which fiber core wires of two optical fibers are arc-fused by using an optical fiber fusion splicer (splicer) has been frequently used, and after the splicing, a spliced portion is covered with a sleeve, which is heated and heat-shrunk, thereby protecting the spliced portion.

Further, the optical fiber fusion splicer includes a pair of fiber clamp mechanisms each clamping each of the two optical fibers to be spliced, and as an example, the both fiber clamp mechanisms are structured such that they are covered by a cover attached to an upper surface of the optical fiber fusion splicer, and when the cover is opened, the both fiber clamp mechanisms are exposed to the outside.

FIG. 8 illustrates a structure of one of the pair of fiber clamp mechanisms, and in the drawing, 1 denotes a block-shaped fiber receiving base having a V-groove 5 for holding an optical fiber 3 formed on an upper surface thereof as illustrated in FIG. 9 and FIG. 10, 7 denotes a clamp head for clamping the optical fiber 3 held by the V-groove 5, from above, and the fiber receiving base 1 is screwed at a predetermined place 11 of a fiber clamp mechanism 9. Further, generally, the V-groove 5 is set to have a length dimension L1 of 4 mm, in order to stably hold the optical fiber 3 and to stabilize a linearity of the optical fiber 3.

Meanwhile, as illustrated in FIG. 10, the clamp head 7 is attached at a predetermined place of the fiber clamp mechanism 9 via a supporting shaft 13 in a manner that it can rotate in arrow marks A, B directions, and to a tip of an arm 15 of the clamp head 7, there is attached a stay 19 spring-biased downward by a spring member 17. Further, to a tip of the stay 19, a clamp tip 23 on which a V-shaped pressing portion 21 fitted to the V-groove S is formed as in FIG. 11 is attached, and the clamp tip 23 is pivotally attached to a tip of the stay 19 in a freely movable manner (free state) in an attachment hole 25 on an upper surface thereof into which the tip of the stay 19 is inserted.

The fiber clamp mechanism 9 is structured as above, and as in FIG. 8, when a splice end of the optical fiber 3 is disposed in the V-groove 5 while fixing a fiber holder 27 attached to a splicing side of the optical fiber 3 being one of the two optical fibers to be spliced, to a predetermined portion 29 of the fiber clamp mechanism 9, and thereafter, the arm 15 of the clamp head 7 is rotated in the arrow mark A direction to fit the V-shaped pressing portion 21 of the clamp tip 23 to the V-groove 5 as illustrated in FIG. 12 and FIG. 13, a smooth surface 31 provided at a tip of the V-shaped pressing portion 21 of the clamp tip 23 biased by the spring member 17 presses the optical fiber 3, resulting in that the optical fiber 3 is line-contacted with the V-groove 5 to be clamped.

Note that although not illustrated, the fiber clamp mechanism for clamping the other optical fiber of the two optical fibers to be spliced is also structured in the same manner as the aforementioned fiber clamp mechanism 9, and is attached on an opposite side of the aforementioned fiber clamp mechanism 9 with electrode of the optical fiber fusion splicer therebetween.

Incidentally, when clamping an optical fiber using the aforementioned fiber clamp mechanism 9, the clamping of optical fiber with a fiber diameter φ of less than 400 μm is stably performed because an amount of curl of fiber jacket is small, but, regarding an optical fiber with a fiber diameter φ exceeding 400 μm, an amount of curl of fiber jacket is large and the curl cannot be straightened, so that there is a possibility that the optical fiber cannot be held and the linearity of the optical fiber is lost, which deteriorates quality of splicing.

For this reason, regarding the optical fiber with the fiber diameter φ exceeding 400 μm, there has been conventionally taken a measure such that a rather long portion of a fiber jacket 33 is removed as illustrated in FIG. 8, and a glass core wire portion (fiber core wire) 35 which is easy to be straightened is clamped by the clamp tip 23 and the fiber receiving base I (the V-groove 5).

Note that as an example, since the fusion splicing with the use of the electrode is conducted, a dimension of lead wire L2 of the glass core wire portion 35 after removing the fiber jacket 33 is 13 mm, as illustrated in FIG. 12.
Patent Document 1: Japanese Unexamined Patent Application Publication No. H09-43445

### DISCLOSURE

### Problems to be Solved

However, as described above, when clamping the glass core wire portion 35, the length of removal of the fiber jacket 33 (the aforementioned dimension of lead wire L2) becomes long, so that inevitably, a sleeve for protecting a spliced portion becomes long and large, resulting in that a weight of the entire spliced optical fibers is increased.

As a result of this, there was a problem that the workability is poor, since it is not possible to freely dispose a sleeve portion on a fiber-forming route, and there is a restriction in terms of mounting in which the sleeve portion is linearly fixed to prevent an occurrence of optical loss (transmission loss) caused when the optical fiber coming out from both ends of the sleeve is extremely bent.

The present invention has been devised in view of such actual circumstances, and a proposition thereof is to provide a fiber clamp mechanism of an optical fiber fusion splicer capable of reducing a size of a sleeve covering a spliced portion of fusion-spliced optical fibers, regardless of a fiber diameter, thereby enabling realization of mounting-free.

### Means for Solving the Problems

In order to achieve such a proposition, an invention according to a first aspect of embodiment is a fiber clamp mechanism of an optical fiber fusion splicer characterized in that it includes: a fiber receiving base having a V-groove formed on an upper surface thereof; and a clamp tip attached to a tip of a stay which is attached by being spring-biased to a rotatable arm of a clamp head, and having a V-shaped pressing portion formed along the V-groove, in which the fiber receiving base is formed to have a substantially L-shaped cross section in which a thin-walled projecting piece is provided to project upward, and the V-groove with a thin wall holding an optical fiber is formed on an upper surface of the projecting piece, the clamp tip is formed to have a substantially L-shaped cross section in which a projecting piece having the V-shaped pressing portion with a thin wall formed along the V-groove projects downward and is fixed to the tip of the stay, and a tip of the V-shaped pressing portion that is pressure-contacted with an outer periphery of the optical fiber is formed to have an R-shape along an axial direction of the optical fiber.

Further, an invention according to a second aspect of embodiment is characterized in that in the fiber clamp mechanism of the optical fiber fusion splicer described in a first aspect of embodiment, the projecting piece of the fiber receiving base and the projecting piece of the clamp tip are projected in a diagonal direction on a side of an electrode of the optical fiber fusion splicer.

In the invention according to a first aspect of embodiment,

(1) the fiber receiving base is formed to have the substantially L-shaped cross section, and the thin-walled V-groove and the clamp tip having the thin-walled V-shaped pressing portion formed thereon are used, so that it becomes possible to shorten the length of removal of the fiber jacket, compared with a conventional case,

(2) further, by rigidly fixing the clamp tip to the tip of the stay, there is no chance of inclination of optical fiber even when the optical fiber is clamped with the thin walls, and

(3) since the tip of the V-shaped pressing portion is formed to have the R-shape along the axial direction of the optical fiber, it is possible that a substantially center of the tip of the V-shaped pressing portion is point-contacted with the optical fiber to press it against the V-groove, without depending on an attachment accuracy of the clamp tip rigidly fixed to the tip of the stay, resulting in that the optical fiber can be stably held and the linearity of the optical fiber can be stabilized.

Therefore, in the invention according to the first aspect of the embodiment, it becomes possible to reduce a size of a sleeve covering a spliced portion of fusion-spliced optical fibers regardless of a fiber diameter, which results in realizing mounting-free, and because of a reduction in the number of fixing members for fixing the sleeve and an easing of restriction on fiber-forming route, the number of wiring work processes can be reduced.

Further, since it is only required to change the fiber receiving base and the clamp tip of the existing fiber clamp mechanism, and there is no need to make a change to the other structures of the existing equipment, there are advantages that the equipment can be provided at a low cost and it can be used for various purposes.

Further, the invention according to a second aspect of embodiment has advantages that, since the projecting piece of the fiber receiving base and the projecting piece of the clamp tip are projected in the diagonal direction on the side of the electrode, the length of removal of the fiber jacket can be further shortened, resulting in that the size of the sleeve can be further reduced.

### BRIEF DESCRIPTION OF THE DRAWINGS

FIG. 1 is a front view of a fiber clamp mechanism according to the first aspect of the embodiment.

FIG. 2 is a perspective view of a fiber receiving base used in the fiber clamp mechanism in FIG. 1.

FIG. 3 is a side view of the fiber clamp mechanism in FIG. 1.

FIG. 4 is a perspective view of a clamp tip used in the fiber clamp mechanism in FIG. 1.

FIG. 5 is a front view of the fiber clamp mechanism that clamps an optical fiber.

FIG. 6 is a side view of the fiber clamp mechanism that clamps the optical fiber.

FIG. 7 is a front view of a fiber clamp mechanism according to the first aspect of the embodiment and the second aspect of the embodiment.

FIG. 8 is a front view of a conventional fiber clamp mechanism.

FIG. 9 is a perspective view of a fiber receiving base used in the conventional fiber clamp mechanism.

FIG. 10 is a side view of the conventional fiber clamp mechanism.

FIG. 11 is a perspective view of a clamp tip used in the conventional fiber clamp mechanism.

FIG. 12 is a front view of the conventional fiber clamp mechanism that clamps an optical fiber.

FIG. 13 is a side view of the conventional fiber clamp mechanism that clamps the optical fiber.

### DETAILED DESCRIPTION OF THE EMBODIMENTS

Hereinafter, embodiments of the present invention will be described based on the drawings.

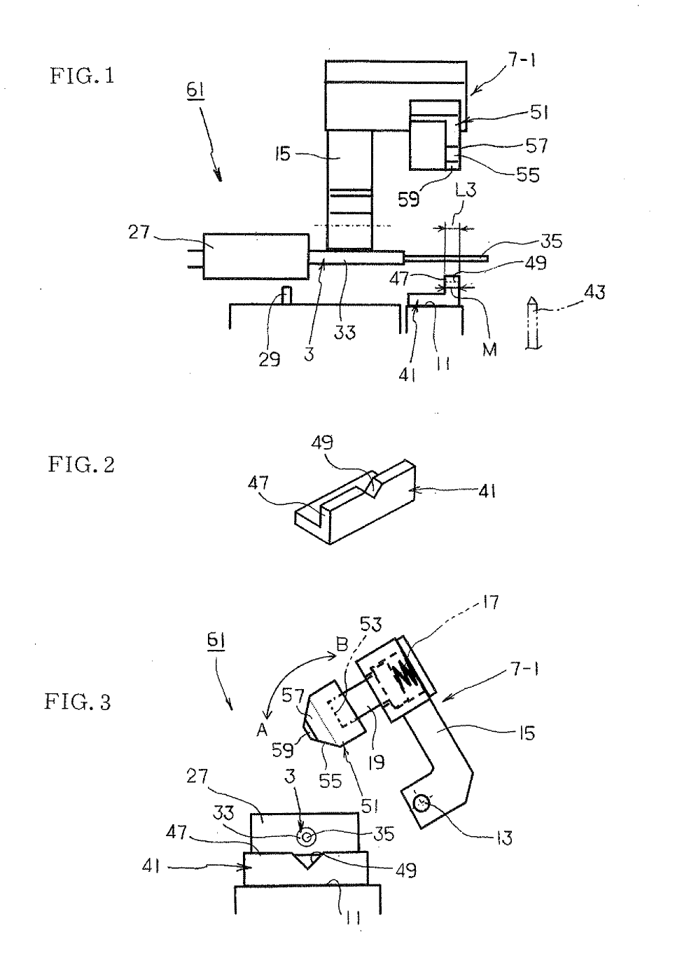

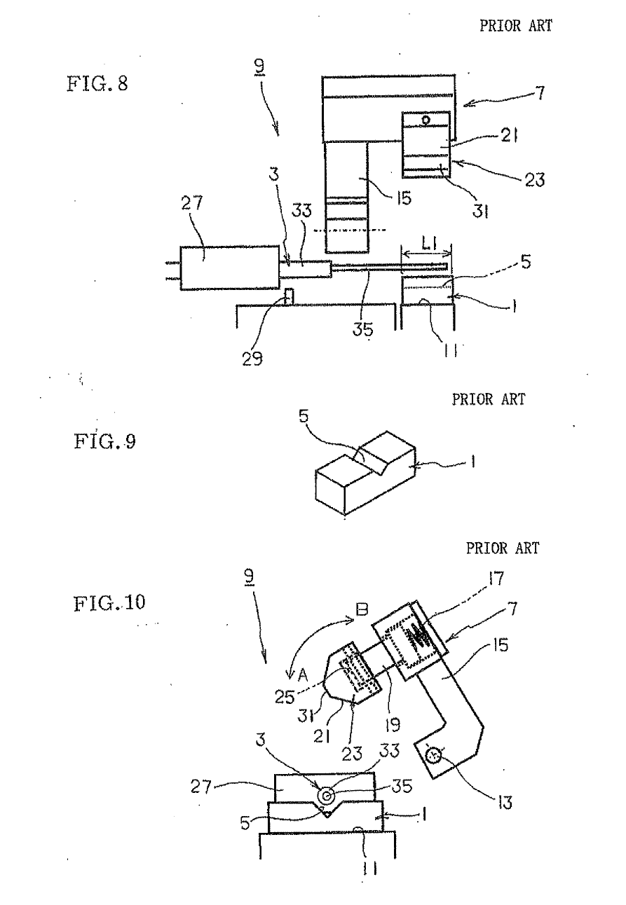

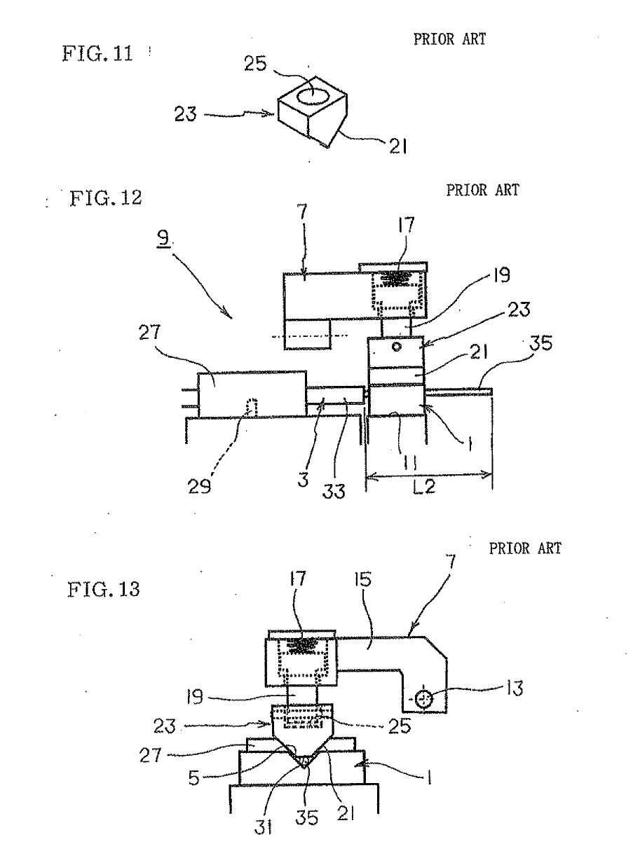

FIG. 1 illustrates a fiber clamp mechanism according to the first aspect of the embodiment in which one of two optical fibers to be fusion-spliced is clamped, and in the present embodiment, structures of a clamp tip and a fiber receiving base are different from those of the fiber clamp mechanism 9 in FIG. 8, and elements same as those of the conventional example in FIG. 8 are denoted by the same reference numerals, and explanation thereof will be omitted.

In FIG. 1, 41 denotes a fiber receiving base having an L-shaped cross section in which a thin-walled (wall thickness M=1 mm) projecting piece 47 is provided to project upward on a side of electrode 43 of an optical fiber fusion splicer, and the fiber receiving base 41 is screwed at the same predetermined place 11 as that of the fiber receiving base 1.

Further, as illustrated in FIG. 1 to FIG. 3, there is formed, on a center of an upper surface of the projecting piece 47, a thin-walled V-groove 49 with a length dimension L3=mm for holding the glass core wire portion 35 of the optical fiber 3, and by forming the fiber receiving base 41 to have the substantially L-shaped cross section and providing the V-groove 49 with a thin wall as described above, it becomes possible to shorten the length of removal of the fiber jacket 33 of the optical fiber 3 (dimension of lead wire L4=4 mm), compared with the conventional example in FIG. 12, as illustrated in FIG. 5.

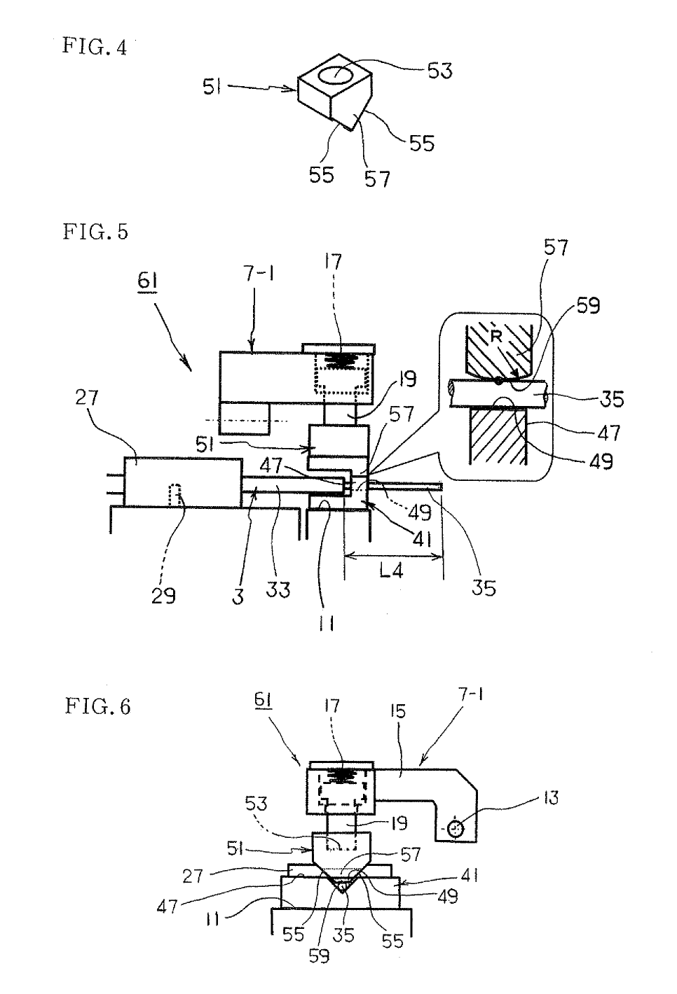

Further, FIG. 4 illustrates a clamp tip 51 attached to a tip of the stay 19 of a clamp head 7-1 spring-biased by the spring member 17, and to an attachment hole 53 provided at a center of an upper surface of the clamp tip 51, a tip of the stay 19 is rigidly fixed.

Further, as illustrated in FIG. 1, FIG. 3 to FIG. 6, the clamp tip 51 is formed to have a substantially L-shaped cross section in which a projecting piece 57 having a thin-walled V-shaped pressing portion 55 formed along the V-groove 49 projects downward, and as illustrated in FIG. 5, the V-shaped pressing portion 55 is formed to have the same wall thickness as that of the V-groove 49, and is structured to clamp the optical fiber 3 (glass core wire portion 35) together with the V-groove 49 from above and below with a width of 1 mm.

Further, as illustrated in FIG. 5, a tip 59 of the V-shaped pressing portion 55 that is pressure-contacted with an outer periphery of the optical fiber 3 is formed to have an R-shape along an axial direction of the optical fiber 3, and by forming the tip 59 of the V-shaped pressing portion 55 to have the R-shape as described above, it is possible that a substantially center of the tip 59 of the V-shaped pressing portion 55 is point-contacted with the optical fiber 3 (glass core wire portion 35) to press it against the V-groove 49, without depending on an attachment accuracy of the clamp tip 51 rigidly fixed to the tip of the stay 19.

A fiber clamp mechanism 61 is structured as above, and although not illustrated, a fiber clamp mechanism for clamping the other optical fiber of the two optical fibers to be spliced is also structured in the same manner as the aforementioned fiber clamp mechanism 61, and is attached on an opposite side of the aforementioned fiber clamp mechanism 61 with the electrode 43 therebetween. Further, these fiber clamp mechanisms 61 are structured such that they are covered by a cover attached to an upper surface of the optical fiber fusion splicer, and when the cover is opened, the both fiber clamp mechanisms 61 are exposed to the outside.

The present embodiment is structured as above, so that when clamping the optical fiber 3 to be fusion-spliced by using the fiber clamp mechanism 61, as illustrated in FIG. 1, the fiber jacket 33 on the splicing side of the optical fiber 3 to which the fiber holder 27 is attached is removed as much as the aforementioned dimension of lead wire L4, and thereafter, while attaching the fiber holder 27 to the predetermined portion 29 of the fiber clamp mechanism 61, the glass core wire portion 35 is disposed in the V-groove 49 of the fiber receiving base 41.

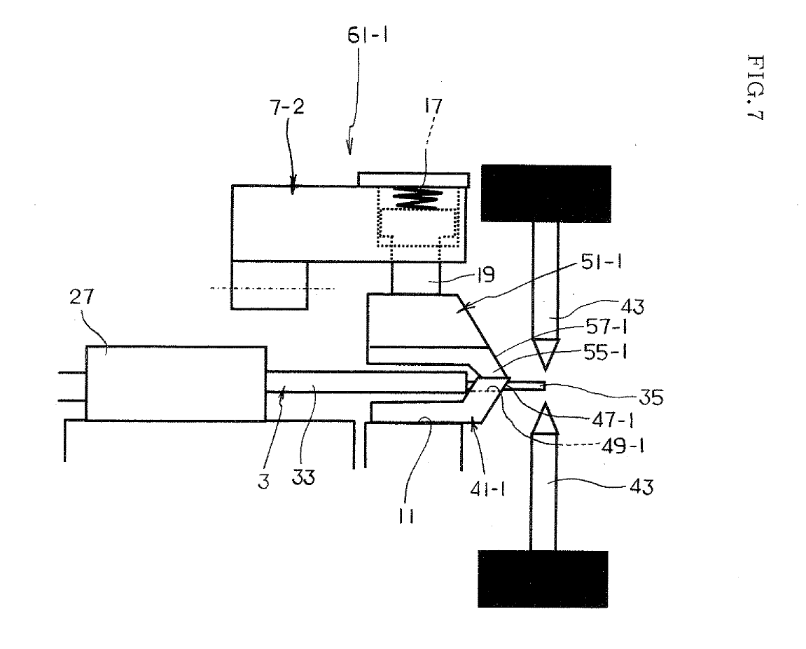

After that, as illustrated in FIG. 5 and FIG. 6, when the arm 15 of the clamp head 7-1 is rotated in the arrow mark A direction to make the thin-walled V-shaped pressing portion 55 of the clamp tip 51 fit to the thin-walled V-groove 49, the substantially center of the tip 59 of the V-shaped pressing portion 55 formed to have the R-shape is point-contacted with the glass core wire portion 35 of the optical fiber 3 to clamp it with the V-groove 49, without depending on the attachment accuracy of the clamp tip 51 rigidly fixed to the tip of the stay 19, resulting in that the optical fiber 3 can be stably held and the linearity of the optical fiber 3 can be stabilized.

In like manner, when the other optical fiber to be spliced is clamped by the fiber clamp mechanism attached on the opposite side of the aforementioned fiber clamp mechanism 61 with the electrode 43 therebetween, tips of the glass core wire portions 35 of the two optical fibers 3 to be spliced are disposed between the electrode 43, and thereafter, the both optical fibers 3 may be fusion-spliced.

As described above, in the present embodiment,

(1) the fiber receiving base 41 is formed to have the substantially L-shaped cross section, and the thin-walled V-groove 49 with a length dimension L3=1 mm and the clamp tip 51 having the thin-walled V-shaped pressing portion 55 with the same dimension as that of the V-groove 49 formed thereon are used, so that compared with the conventional case, it becomes possible to shorten the length of removal of the fiber jacket 33,

(2) further, by rigidly fixing the clamp tip 51 to the tip of the stay 19, there is no chance of inclination of the optical fiber 3 even when the optical fiber is clamped with the thin walls, and

(3) furthermore, since the tip 59 of the V-shaped pressing portion 55 is formed to have the R-shape along the axial direction of the optical fiber 3, it is possible that the substantially center of the tip 59 of the V-shaped pressing portion 55 is point-contacted with the optical fiber 3 (glass core wire portion 35) to press it against the V-groove 49, without depending on the attachment accuracy of the clamp tip 51 rigidly fixed to the tip of the stay 19, resulting in that the optical fiber 3 can be stably held and the linearity of the optical fiber 3 can be stabilized.

Therefore, according to the present embodiment, it becomes possible to reduce a size of a sleeve covering a spliced portion of fusion-spliced optical fibers regardless of a fiber diameter, which results in realizing mounting-free, and because of a reduction in the number of fixing members for fixing the sleeve and an easing of restriction on fiber-forming route, the number of wiring work processes can be reduced.

Further, according to the present embodiment, since it is only required to change the fiber receiving base and the clamp tip of the existing fiber clamp mechanism to the above-described fiber receiving base 41 and clamp tip 51, and there is no need to make a change to the other structures of the existing equipment, there are advantages that the equipment can be provided at a low cost and it can be used for various purposes.

FIG. 7 illustrates a fiber clamp mechanism according to the first aspect of the embodiment and the second aspect of the embodiment, and as illustrated in the drawing, a fiber clamp mechanism 61-1 according to the present embodiment includes, instead of the projecting piece 47 of the fiber receiving base 41 and the projecting piece 57 of the clamp tip 51 of the aforementioned fiber clamp mechanism 61, a projecting piece 47-1 of a fiber receiving base 41-1 and a projecting piece 57-1 of a clamp tip 51-1 which are respectively projected in a diagonal direction on the side of the electrode 43, to thereby form each of the fiber receiving base 41-1 and the clamp tip 51-1 to have a substantially L-shaped cross section.

Further, similar to the aforementioned embodiment, there is formed, on a center of an upper surface of the projecting piece 47-1 of the fiber receiving base 41-1, a thin-walled V-groove 49-1 having the same length as that of the aforementioned V-groove 49, and there is formed, on the projecting piece 57-1 of the clamp tip 51-1, a thin-walled V-shaped pressing portion 55-1 along the aforementioned V-groove 49-1.

Note that the other structures are similar to those of the embodiment in FIG. 1, so that the same elements are denoted by the same reference numerals, and explanation thereof will be omitted.

As described above, according to the present embodiment in which the projecting piece 47-1 of the fiber receiving base 41-1 and the projecting piece 57-1 of the clamp tip 51-1 are projected in the diagonal direction on the side of the electrode 43, there are advantages that the length of removal of the fiber jacket 33 can be further shortened, resulting in that the size of the sleeve can be further reduced, compared with the embodiment in FIG. 1.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to exact construction and operation illustrated and described, and accordingly all suitable modifications and equivalents may be resorted to, falling within the scope thereof.

1. A fiber clamp mechanism of an optical fiber fusion splicer, comprising:
a fiber receiving base having a V-groove formed on an upper surface thereof; and
a clamp tip attached to a tip of a stay which is attached by being spring-biased to a rotatable arm of a clamp head, and having a V-shaped pressing portion formed along the V-groove, wherein:
the fiber receiving base is formed to have a substantially L-shaped cross section in which a thin-walled projecting piece is provided to project upward, and the V-groove with a thin wall holding an optical fiber is formed on an upper surface of the projecting piece;
the clamp tip is formed to have a substantially L-shaped cross section in which a projecting piece having the V-shaped pressing portion with a thin wall formed along the V-groove projects downward and is fixed to the tip of the stay; and
a tip of the V-shaped pressing portion that is pressure-contacted with an outer periphery of the optical fiber is formed to have an R-shape along an axial direction of the optical fiber.

2. The fiber clamp mechanism of the optical fiber fusion splicer according to claim 1, wherein
the projecting piece of the fiber receiving base and the projecting piece of the clamp tip are projected in a diagonal direction on a side of an electrode of the optical fiber fusion splicer.
